(19) United States
(12) Patent Application Publication
(10) Pub. No.: US 2015/0136752 A1
(43) Pub. Date: May 21, 2015

(54) ELECTRICAL HEATING ASSEMBLY FOR A DEFROSTING DEVICE

(71) Applicant: AIRCELLE, GONFREVILLE L'ORCHER (FR)

(72) Inventors: Marc GEROME, LE HAVRE (FR); Xavier CAZUC, LE HAVRE ROUELLES (FR); David PEREIRA, Montigny-le-Bretonneux (FR)

(21) Appl. No.: 14/578,079

(22) Filed: Dec. 19, 2014

Related U.S. Application Data
(63) Continuation of application No. PCT/FR2013/051464, filed on Jun. 24, 2013.

(30) Foreign Application Priority Data
Jun. 25, 2012 (FR) 12/55982

(51) Int. Cl. B64D 33/02; B64D 15/12

(52) U.S. Cl. CPC B64D 33/02; B64D 15/12; B64D 2033/0233
USPC 219/202; 219/552; 219/539; 29/611

(57) ABSTRACT

An electrical heating assembly is provided for a defrosting device of an air-intake lip of a turbojet engine nacelle. The electrical heating assembly includes a current-conductive portion and a resistive portion, and the resistive portion includes strips spaced apart one another. Each strip is connected to the current-conductive portion so as to form at least one recess in the resistive portion.

### CROSS-REFERENCE TO RELATED APPLICATIONS

This application is a continuation of International Application No. PCT/FR2013/051464, filed on Jun. 24, 2013, which claims the benefit of FR 12/55982, filed on Jun. 25, 2012. The disclosures of the above applications are incorporated herein by reference.

### FIELD

The present disclosure relates to an electrical heating assembly for a device of defrosting an air-intake lip of a turbojet engine nacelle and a method of manufacturing such an electrical heating assembly.

### BACKGROUND

The statements in this section merely provide background information related to the present disclosure and may not constitute prior art.

An aircraft is propelled by one or more propulsive assembly/assemblies each comprising a turbojet engine housed in a substantially tubular nacelle.

A nacelle presents in a general way a substantially tubular structure surrounding the turbojet engine and comprises, an air intake upstream of the engine, a middle section intended to surround a fan of said turbojet engine and a downstream section surrounding the combustion chamber of the turbojet engine and which can be equipped with thrust reverser means.

The air intake comprises, on the one hand, an intake lip adapted to allow the optimal capture towards the turbojet engine of the air necessary to power the fan and the inner compressors of the turbojet engine, and on the other hand, a downstream structure on which the lip is brought and intended to suitably channel the air towards the fan blades. The assembly is fastened upstream of a fan casing belonging to the middle section of the assembly.

In flight, (and on the ground) according to the temperature, pressure and humidity conditions, ice may be formed on the nacelle, in particular at the outer surface of the air-intake lip. The presence of ice or of frost changes the aerodynamic properties of the air intake and disturbs the routing of the air towards the fan.

A solution to defrost or de-ice the outer surface consists of preventing ice from being formed on this outer surface by maintaining the concerned surface at a sufficient temperature. Thus, it is known for example from document U.S. Pat. No. 4,688,757, to withdraw the hot air at the compressor of the turbojet engine and to deliver it at the air-intake lip in order to warm up the walls. Nevertheless, such a device requires a system of hot air delivery pipe between the turbojet engine and the air intake, as well as an exhaust system of the hot air at the air intake lip. This increases the mass of the propulsive assembly, which is not desirable.

These disadvantages could be overcome thanks to electrical defrosting systems. The document EP 1 845 018 can be in particular cited although many other documents relate to the electrical defrosting and to its developments. The implementation of an electrical defrosting device uses heating resistance assemblies, also called heating mats, implanted at the air-intake lip near the outer surface and electrically powered by an electrical power supply.

The extremely curved geometry of the air-intake lip of a nacelle requires the use of several independent heating mats to allow covering segment by segment the totality of the surface of the air-intake lip of the nacelle. This technical solution is described in the document EP 1 715 159 which discloses a heating assembly constituted of a plurality of bands brought in the area to be treated against the frost.

This operation of integration is particularly long and tedious, because it is manually carried out.

### SUMMARY

The present disclosure provides an electrical heating assembly for a defrosting device, whose integration of said assembly inside a lip of a turbojet engine nacelle is relatively easy and directly carried out during the manufacturing phase of said lip.

To this end, the present disclosure provides an electrical heating assembly for a defrosting device of an air-intake lip of a turbojet engine nacelle, comprising at least one current-conductive portion and at least one resistive portion, said electrical heating assembly being remarkable in that the resistive portion comprises a plurality of adjacent strips spaced from one other and each of which connected to the common current-conductive portion so as to form at least one recess in said resistive portion.

Thus, by providing spaced strips, the electrical heating assembly matches the complex shape of the air-intake lip, and can consequently be easily integrated. It is thus possible to carry out large-size mats, which allows reducing the number of mats necessary for covering a desired surface of the air-intake lip. Also, an electrical heating assembly according to the present disclosure allows covering about ⅙th of the surface of the air-intake lip, which allows reducing the time of integration in the lip of such an assembly.

According to other features of the present disclosure, the strips are spaced in a substantially regular manner along the current-conductive portion.

The resistive portion comprises at least one heating layer each comprising at least one resistive element and at least one insulating element superimposed to said at least one resistive element.

In one form, the resistive portion comprises two heating layers.

Advantageously, each resistive layer can be powered independently of each other.

According to another aspect of the present disclosure, the current-conductive portion comprises at least one phase conductive element associated with at least one neutral or “earth” conductive element.

Said at least one resistive element comprises at least one resistive coil comprising a first end connected to said phase conductive element and a second end connected to said neutral conductive element.

According to other feature of the assembly according to the present disclosure, the current-conductive portion comprises at least one adjacent side to one of the sides of the resistive portion.

The present disclosure also relates to an air-intake lip of a nacelle for turbojet engine, said lip being remarkable in that it comprises at least one electrical heating assembly according to the present disclosure.

The present disclosure also relates to a nacelle for turbojet engine remarkable in that it comprises at least one defrosting device comprising at least one electrical heating assembly according to the present disclosure powered by at least one electrical power supply source.

Finally, the present disclosure relates to method of manufacturing an electrical heating assembly according to the present disclosure, said method being remarkable in that it comprises the following steps:
positioning at least one resistive element between at least two insulating elements so as to form at least one heating layer comprising at least one resistive portion;
positioning at least one conductive element between at least two insulating elements so as to form at least one conductive portion of the electrical heating assembly;
connecting said resistive and conductive portions;
partially cutting said layers so as to form at least two strips of said resistive portion, said strips being spaced from one another by a recess.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 schematically illustrates an electrical heating assembly according to the present disclosure, in top view;

FIG. 2 is a cross-sectional view of a strip of the electrical heating assembly;

FIG. 3 is a longitudinal-sectional view of the assembly according to the present disclosure, illustrating the resistive elements positioned on the current-diffuser portion;

FIGS. 4a and 4b show the connection between the electrical heating assembly and a power supply source of a defrosting device;

FIG. 5 illustrates the electrical heating assembly in a top view; and

FIG. 6 is an isometric view of an air-intake lip portion of a turbojet engine nacelle equipped with the electrical heating assembly according to the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

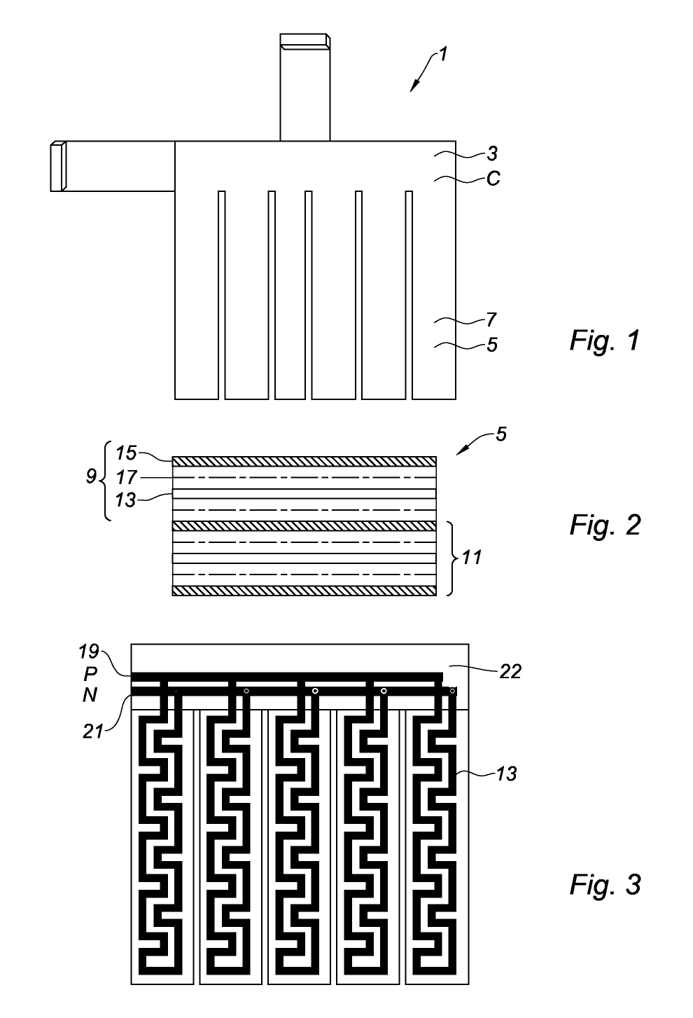

FIG. 1 is referred to, schematically illustrating in a top view the electrical heating assembly according to the present disclosure.

The electrical heating assembly 1 adopts a substantially rectangular comb-like geometry having a current-conductive portion 3 to which a plurality of strips 5 or teeth are secured, along a side C of the assembly 1.

The strips 5 form a resistive portion 7 of the electrical heating assembly 1.

The strips shown in FIG. 1 are of a substantially rectangular shape, regularly spaced, along the side C of the current-conductive portion 3.

According to another form not shown on the figures, the strips 5 are spaced along many sides of the current-conductive portion 3.

Furthermore, the geometry of a strip is likely to change depending on the geometry of the part to which the electrical heating assembly is integrated. More particularly, the radius of curvature of the part to which the electrical heating assembly is intended determines the shape and the dimensions of a strip. A strip can thus adopt a rectangular, triangular, trapezoidal, etc. shape.

In addition, the distance that separates two strips from one another is also variable, according to the needs of the part.

To this end, it is specified that the electrical heating assembly according to the present disclosure is, in one form, intended to be integrated to a composite, monolithic or sandwich air-intake lip of a turbojet engine nacelle. Of course, the heating assembly can also equip other areas of the nacelle. Moreover, neither is such an assembly restricted to an application in the field of aeronautics.

FIG. 2 illustrates a rectangular strip 5 in cross section. The strip 5 comprises two superimposed heating layers 9 and 11, each comprising a resistive element 13 surmounted both sides by an insulating element 15.

Typically, the resistive element 13 is made thanks to an electrically conductive metallic material, and the insulating element 15 is in turn made for example from a glass ply.

Of course, the resistive elements and the insulating elements may be made of any other electrically conductive and insulating material respectively.

The maintaining between a resistive element 13 and an insulating element is made thanks to adhesive means such as the glue 17, for example.

The number of heating layers can be adapted depending on the needs of the skilled in the art.

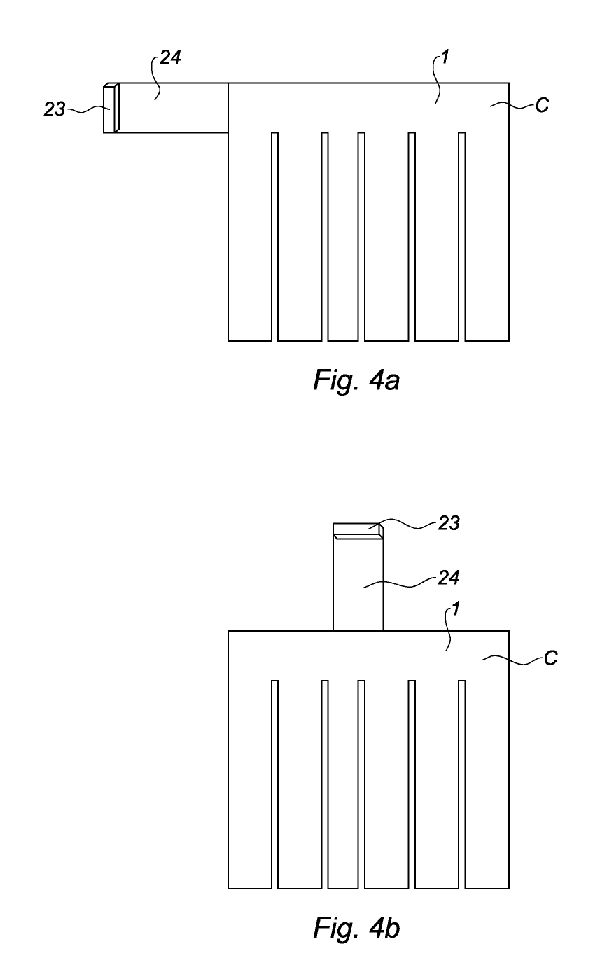

Referring now to FIG. 3, which illustrates the electrical heating assembly in longitudinal section.

The insulating element 15 receives on its upper face a conductive element 19, for example and as shown, a phase conductive wire element P, associated with a conductive element 21, for example and as shown, an N-neutral conductive wire element.

The phase conductor P and the neutral conductor N are grouped together along a same side 22 of the insulating element 15.

FIGS. 4a and 4b are referred to. The phase and neutral conductors are connected to a power supply source 23 of a defrosting device.

The power supply source is housed in the air-intake lip (not shown) or near, inside the nacelle.

The power supply source may further be equally housed in the fuselage of the aircraft.

According to the form shown in FIG. 4a, the power supply source 23 is located in the extension of the side 22 of the insulating element 15. According to another form shown in FIG. 4b, the power supply source is located in the extension of the side perpendicular to said side C.

The phase and neutral conductors transit, between the power supply source 23 and electrical heating assembly 1, inside a flexible element 24, for example made of a material of Kapton® type.

Returning to FIG. 3, the resistive element 13 adopts a coil shape, one of its ends is connected to the phase conductor P and the other of its ends is connected to the neutral conductor N. The tracks of the coil are parallel, which advantageously allow to reduce significantly the surface of inductive loop formed by the coil.

Nevertheless, it should be noted that the shape of the resistive elements is adapted depending on the geometry of the assembly strips. Thus, the resistive elements may have a shape other than that described above and shown in FIG. 3.

The resistive elements 13 are connected to the same phase conductor and neutral conductor. They are thus powered in parallel.

Each heating layer is equipped with resistive elements 13 as previously described.

Thus each heating layer is electrically independent from one another, that is to say each layer can be powered simultaneously or independently from one other, depending on the required heating intensity.

Moreover, the independent power supply of each one of the layers of the electrical heating assembly allows to radiate the heat to the lip in “degraded” mode, in case of malfunction of one of the layers.

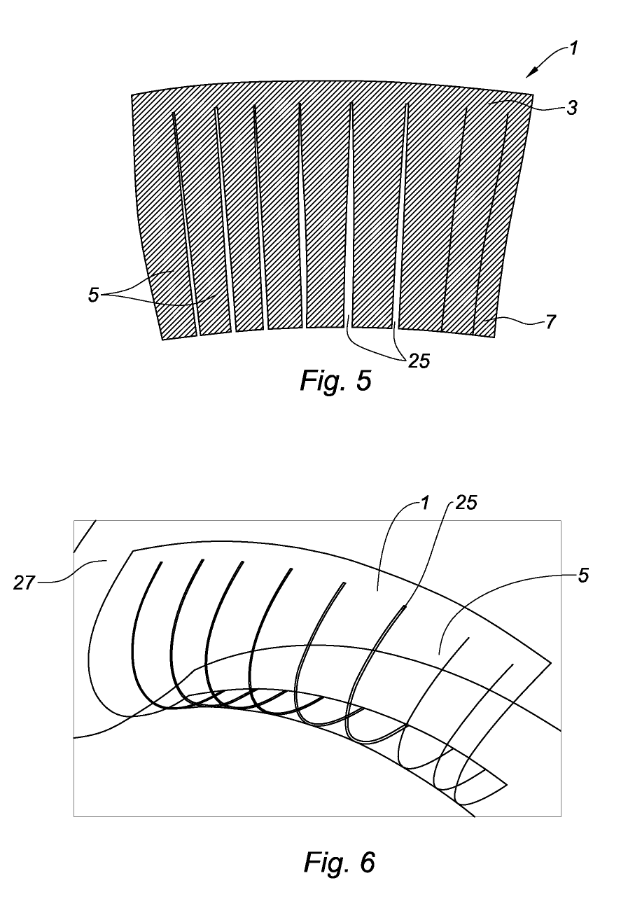

Referring now to FIG. 5, illustrating the electrical heating assembly according to the present disclosure, in top view, placed flat.

The electrical heating assembly 1 is carried out according to the manufacturing method according to the present disclosure.

For this, a resistive element is positioned on a first insulating member, typically a glass ply, which is covered by a second insulating element, so as to form a heating layer and a resistive portion. A conductive element is also positioned between the two insulating elements so as to form a conductive portion of the electrical heating assembly. Then, said conductive and resistive portions are connected.

This step of the method is iterated until the desired number of layers is obtained. The electrical heating assembly, having a substantially parallelepiped shape is obtained.

It is noted that the positioning of the resistive elements on the insulating elements depends on the geometry of the area of the part intended to support the electrical heating assembly.

The cutting step is then carried out thanks to a tooling known from the prior art. For this, the electrical heating assembly is positioned flat and portions of said assembly are cut out so as to form recesses 25 in the resistive portion 7.

The recesses allow on the one hand the easy integration of the electrical assembly into the part to be equipped, and on the other hand, a broad covering of the surface of said part. To this end, each of the recesses 25 can adopt a specific shape different from the other recesses of the assembly, as shown in FIG. 5.

The electrical heating assembly 1 is thus able to be easily integrated in an air-intake lip 27 of a nacelle, as shown in FIG. 6. When the electrical heating assembly is positioned in the lip 27, the spacing between two adjacent strips is substantially constant.

Thanks to the present disclosure, the method of integration of an electrical heating assembly for a defrosting device in the air-intake lip of a nacelle is simplified.

Indeed, the presence of recesses between the strips allows to reduce the time of integration in the lip. The presence of recesses between the strips also greatly facilitates the insertion of the electrical heating assembly in the lip of the nacelle, while allowing said assembly to match to the geometrical shape of said lip. Furthermore, the integration of such a heating assembly may advantageously be carried out during the manufacturing phase of the air-intake lip of the nacelle.

Finally, an electrical heating assembly according to the present disclosure may allow to cover up to about ⅙th of the air-intake lip of the nacelle, which allows to avoid having to manually position segment by segment many heater assemblies with smaller size, as is the case in the prior art.

It goes without saying that the present disclosure is not solely limited to the sole forms of this electrical heating assembly, of this nacelle integrating such an assembly or of the manufacturing method of such an assembly, described above by way of examples, but it contrarily encompasses all the alternatives, and in particular, and by way of example only, those where the electrical heating assembly is integrated to a leading edge of a wing or of a tail unit, of a “winglet”, of the radome, or even of blades of turboprop or of helicopter.

What is claimed is:

1. An electrical heating assembly for a defrosting device of an air-intake lip of a turbojet engine nacelle, comprising:
at least one current-conductive portion; and
at least one resistive portion, wherein said resistive portion comprises a plurality of adjacent strips spaced apart one another, each strip connected to said current-conductive portion, so as to form at least one recess in said resistive portion.

2. The electrical heating assembly according to claim 1, wherein the strips are spaced in a substantially regular manner along said current-conductive portion.

3. The electrical heating assembly according to claim 1, wherein said resistive portion comprises at least one heating layer each comprising at least one resistive element and at least one insulating member superimposed to said at least one resistive element.

4. The electrical heating assembly according to claim 1, wherein said resistive portion comprises two resistive layers.

5. The electrical heating assembly according to claim 4, wherein each resistive layer is powered independently of one another.

6. The electrical heating assembly according to claim 1, wherein said current-conductive portion comprises at least one phase conductive element associated with at least one neutral or “earth” conductive element.

7. The electrical heating assembly according to claim 6, wherein said resistive portion comprises at least one heating layer each comprising at least one resistive element, and said resistive element comprises at least one resistive coil comprising a first end connected to said phase conductive element and a second end connected to said neutral conductive element.

8. The electrical heating assembly according to claim 1, wherein said current-conductive portion comprises at least one side adjacent to one of the sides of said resistive portion.

9. An air-intake lip of a nacelle for turbojet engine, further comprising at least one electrical heating assembly according to claim 1.

10. A nacelle for turbojet engine, further comprising at least one defrosting device which comprises at least one electrical heating assembly according to claim 1, said electrical heating assembly powered by at least one electrical power supply source.

11. A method for manufacturing an electrical heating assembly according to claim 1, said method comprising the following steps:
positioning at least one resistive element between at least two insulating elements so as to form at least one heating layer comprising said at least one resistive portion;
positioning at least one conductive element between said at least two insulating elements so as to form said at least one current-conductive portion of the electrical heating assembly;
connecting said resistive and current-conductive portions; and
partially cutting said at least one heating layer so as to form at least two strips of said resistive portion, said strips being spaced apart one another by a recess.
